(19) United States
(12) Patent Application Publication
(10) Pub. No.: US 2009/0208406 A1
(43) Pub. Date: Aug. 20, 2009

(54) LOW TEMPERATURE ACTIVATION OF METAL HYDRIDES

(75) Inventors: Gholam-Abbas Nazri, Bloomfield Hills, MI (US); Vinay Venkatraman Bhat, Oak Ridge, TN (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., DETROIT, MI (US)

(21) Appl. No.: 12/033,952

(22) Filed: Feb. 20, 2008

(51) Int. Cl. C01B 6/00

(52) U.S. Cl. 423/645

(57) ABSTRACT

Hydrogen storage alloys, especially as newly formed, have often required high temperature (e.g., >700° C.) activation before the solids will absorb an amount of hydrogen normally storable by the composition. Now, such alloys may be activated by a low temperature (typically below zero degrees Celsius) soak in pressurized hydrogen followed by desorption of the hydrogen at a temperature above about 100° C. Such low temperature hydrogen absorption and higher temperature hydrogen desorption may be repeated a few times until the hydrogen storage alloy material readily absorbs and holds hydrogen for release on demand, and subsequent hydrogen refilling.

### TECHNICAL FIELD

Certain metals and alloys have the capability of storing hydrogen as metal hydrides in their crystalline or amorphous structure. This invention pertains to a treatment (activation) of such alloys, especially new ingots of such materials, so that they more readily store hydrogen.

### BACKGROUND OF THE INVENTION

Some combinations of transition groups metals (e.g., certain metal elements in Groups IIB-VIIB and VIII of the Periodic table) form AB₂-type crystalline alloys. Many of these alloys are capable of storing appreciable quantities of hydrogen.

The A and B constituents may each be a single transition element, as in TiCr₂, or each A and B constituent may include more than one element, as in alloys in which titanium mixed with some zirconium constitute the A constituent and mixtures of manganese, vanadium, and iron constitute the B constituent. AB₂ alloys with two major prototype crystal structures of hexagonal C14 (MgZn₂ type) and cubic C15 (MgCu₂ type) are known as Laves Phase. There are also AB₂ hexagonal C36 (MgNi₂) structures. In the AB₂ class of alloys, particularly the hexagonal C14 structure (Laves Phase), there are four formula units per unit cell. There are 17 interstitial sites per formula unit, 12A₂B₂, 4 AB₃, and one B₄. The A constituent atoms also are arranged to form hexagonal structures and the B constituent atoms form tetrahedra around the A atoms. The various tetrahedral sites may accommodate hydrogen atoms. The tetrahedral sites with more A elements (hydride forming elements) accept hydrogen atoms more easily. There are other interstitial sites with different compositions and geometries as well.

Many AB₂ metal alloys may be prepared so that they have the capability of absorbing substantial amounts of hydrogen atoms into their crystal structure as metal hydrides. TiCr₂, for example, may absorb, hold, and release hydrogen in an amount of about three percent by weight of the titanium-chromium alloy at useful working temperatures, for example, in the range of from about −30° C. to about 80° C. Such materials have received attention due to their potential use in nickel-hydride batteries. Further, Laves phase metal hydride-forming materials have also been investigated as candidates for hydrogen storage tanks for hydrogen consuming fuel cells and other hydrogen consuming power plants.

AB₂ metal hydride-forming alloys (and other metal hydride forming alloys) are often formed from elemental constituents by suitable melting practices (e.g., arc melting, induction melting) under protective (non-oxidizing) atmospheres. Melting practices often yield ingots of the fused constituents. The ingots are often crushed and the powdered elemental constituents are ball milled to finer particles and annealed to form alloy powder particles having representative grain sizes of about twenty micrometers. While the prepared alloy has the elemental constituents of a composition known for abundant hydrogen adsorption and release, the as-prepared material may not yet display its hydrogen storage potential. As-prepared alloy ingots or particles may, for example, be covered with a thin oxide layer that prevents timely and full expected hydrogenation.

In most applications the prepared metal hydrides require an activation process to enhance their hydrogen sorption kinetics. The activation process of metal hydrides produces small particles with oxide-free surfaces. Activation practices for Laves phase metal hydrides involve a high temperature annealing (>700° C.) under vacuum and hydrogen absorption at ambient temperature under a high pressure (>200 bars). Sometimes the high temperature annealing and hydrogen pressurization must be repeated to suitably activate the crystalline metal alloy material to thereafter absorb and release hydrogen in accordance with its hydrogen storage potential.

It is an object of this invention to provide activation methods for inadequate hydrogen-absorbing AB₂ metal hydrides (and other metal hydride compositions) that do not require such high processing temperatures (and such large temperature ranges) or such high hydrogen pressures.

### SUMMARY OF THE INVENTION

In accordance with this invention particles, ingots, or the like of a metal alloy material are prepared in an “activated” condition so that they are capable of rapidly absorbing, holding, and releasing hydrogen at working temperatures, typically within fifty degrees or so, above or below representative ambient temperatures of about 20° C. to about 30° C. After activation, such metal alloy crystal structures may rapidly absorb hydrogen as metal hydrides. These hydrogen-containing and storing crystal structures yield hydrogen on demand to a hydrogen consuming device. The metal-hydrogen crystal structure gives up its stored hydrogen and a hydrogen-depleted, metal alloy crystal structure is reformed. In some embodiments of the invention, the metal-alloy/metal hydride systems hold hydrogen under a hydrogen gas pressure of, for example, up to about 200 bars at these temperatures.

Such hydrogen-containing, solid metal hydride materials may be placed in a suitable storage vessel adapted for holding pressurized hydrogen gas at the working temperature in which the vessel is located. The solid material is capable of holding more hydrogen than a plain gas-filled vessel of the same volume and under the same pressure. Hydrogen gas may be released from the solid material in the vessel, upon demand, and delivered through a tube or the like to a nearby fuel cell or other hydrogen consuming device. The storage vessel and fuel cell may be used on-board a vehicle to power it. Hydrogen-depleted metal alloy may be recharged from, for example, a suitable external hydrogen delivery system (a hydrogen service station) to restore hydrogen-containing material in (or for) the storage vessel.

For such on-board vehicle applications it is generally specified that a solid, high pressure, hydrogen storage material be capable of functioning at a maximum hydrogen pressure of about 200 bars over a temperature range of about −30° C. to about 80° C. And such metal alloy hydrogen storage materials should be capable of absorbing (during recharging) close to their inherent capacity of hydrogen at a suitable rate and under moderate processing conditions. Laves phase hydrogen storage alloys and other hydrogen storage alloys initially prepared by fusion of their elemental constituents (e.g. solid mixtures of Ti, Cr, Mn, and the like) often initially yield solid alloy bodies or particles that do not readily absorb and hold hydrogen in expected amounts. Many as-prepared hydrogen storage alloys have oxide surface layers even when fused or milled under “non-oxidizing” atmospheres. These oxide surface coatings may be one reason that the alloy particles do not readily absorb the materials inherent capacity of hydrogen even at substantial hydrogen gas pressure.

It is found that cooling new solid hydrogen storage alloys below zero degrees Celsius and subjecting the cold solid material to pressurized hydrogen enhances the ability of the solids to absorb hydrogen. For example, the solids are cooled in a hydrogen-containing vessel to a predetermined temperature from about −30° C. (as in a dry ice-alcohol bath) to about −190° C. (as cooled in liquid nitrogen). The cooled solids are subjected to a predetermined hydrogen pressure, for example up to about 175 bars. The cold solid material is thus soaked in hydrogen for a predetermined period of, for example, about one hour to about three hours. It is believed (but not certain) that cooling the solid material introduces cracks in the surfaces of the particles, chunks, or the like of the alloy due to volume changes upon cooling. Further, hydrogen penetrates the crack-exposed material and fills interstices in the crystal structure, further changing the inherent volume of the material and likely introducing more cracks. By whatever mechanism, cooling and soaking the alloy in hydrogen increases the ability of the material to absorb hydrogen towards the inherent hydrogen storage capacity of the composition.

Hydrogen is then vented from the vessel and the material is rapidly heated from its chilled condition to a temperature, for example in the range of about 100° C. to about 350° C. The heated material is subjected to a low pressure (vacuum) to withdraw hydrogen absorbed in the crystal structure of the solids. The amount of hydrogen thus withdrawn may be measured to compare the withdrawn volume or weight with the perceived inherent capacity of the alloy composition. This heating and removal of the hydrogen is believed to further create potential hydrogen absorbing crevices, voids, and surfaces in the newly formed alloy.

When suitably developed for a specific composition, this process of cooling with pressurized hydrogen absorption followed by heating with hydrogen desorption is found to increase the rate and amount of hydrogen take-up by a hydrogen storage alloy lacking such capacities. The improvement in hydrogen absorption may be measured during a process cycle of a batch of material. Alternatively, the hydrogen absorption properties may be determined on a sample of the storage material after a process cycle. The process may be repeated (often two or three cooling/heating cycles) as necessary to “open up” the alloy for practical and repeated hydrogen storage, release on demand, and hydrogen refilling. Such cooling and heating comprises less extreme processing than prior art activation at 700⁺° C. Less energy is required and less expensive processing equipment.

Other objects and advantages of the invention will be apparent from a description of detailed embodiments of the invention. For example, practices of the invention will be illustrated with the activation of certain TiCrMn-containing, Laves phase, high pressure hydrogen storage alloys. However, the practice of the invention is generally applicable to solid hydrogen storage compositions that are not functioning to absorb their inherent quantities of hydrogen.

### BRIEF DESCRIPTION OF THE DRAWINGS

FIG. 1 includes a pair of graphs illustrating three process cycles of hydrogen pressure-change (in bars) versus time (arbitrary units), the lower curve and corresponding three process cycles of temperature change (° C.) versus time (arbitrary units) cycle, the upper curve, for activation of a newly-prepared Ti_{1.1}—Cr—Mn alloy.

FIG. 2 is a pressure-composition isotherm (PCI) of Ti_{1.1}CrMn powder, activated in accordance with this invention, at −5° C. Hydrogen pressure (bars) versus weight of hydrogen absorbed (in percent of original sample weight) during an absorption cycle and a following desorption cycle is presented in the graph. A comparative PCI for a non-activated sample of Ti_{1.1}CrMn is also presented.

FIG. 3 presents sorption kinetics, also at −5° C., for the activated and non-activated samples of Ti_{1.1}CrMn used in the FIG. 2 PCI data. Weight percent content of hydrogen versus time (s) is shown during adsorption and desorption cycles for the activated and non-activated Ti_{1.1}CrMn samples.

### DESCRIPTION OF PREFERRED EMBODIMENTS

A low temperature and low-pressure activation process has been devised to circumvent activation processes for Laves phase hydrogen storage materials which have included annealing the prepared alloy at greater than 700° C. under vacuum, followed by hydrogen absorption at room temperature at a pressure of 200 bars or greater.

The subject activation process may be applied to newly-prepared (or other inactive) metal alloy compositions to prepare them for greater and more rapid hydrogen absorption and de-sorption. The new process utilizes crystal lattice volume change due to both thermal and hydrogen sorption to fracture the alloy particles and expose fresh alloy surface for hydrogen sorption. A low temperature process (typically below 0° C.) is used to reduce the equilibrium hydrogen sorption pressure plateau. This practice enables the use of lower hydrogen pressure in achieving more complete hydrogenation of the activated metal alloy. Practices of the invention will be illustrated using certain Ti—Cr—Mn based Laves phase alloys but the activation process may be used beneficially on other AB₂ type hydrogen storage materials and, indeed, on other metal hydride compositions.

A Ti_{1.1}CrMn composition was prepared by mixing amounts of titanium, chromium, and manganese powders to achieve the specified atomic proportions. The powder was mixed and compacted into the form of pellets for more efficient heating and melting. The pellets were melted by arc melting under an argon gas atmosphere. Such powder mixtures may also be melted by induction melting or by furnace melting where such equipment is available and the size of the alloy preparation warrants or permits. The molten material may be quenched and processed into a powder or small ingot particles under conditions that minimize oxidation of the alloy. Once a homogeneous alloy has been obtained the powder or larger particles are then ready for the subject activation process of thermal and sorption cycling.

The prepared alloy is cooled to a temperature well below room temperature while subjected to a substantial hydrogen pressure. The processing is preferably conducted with the material in a vessel of known volume so that hydrogen absorption may be determined. For example, on a laboratory scale, a commercial pressure-composition isotherm (PCI) machine may be used to determine the amount of hydrogen absorbed or released from a metal alloy hydride system. Using various newly prepared metal alloys, the materials have been cooled to temperatures from about −30° C. to about −190° C. while subjected to hydrogen pressures from about 100 bars to about 175 bars. The cold materials are hydrogen pressures from about 100 bars to about 175 bars. The cold materials are soaked in the pressurized hydrogen to form surface cracks in the solid material which are penetrated by hydrogen. The specific time for this low temperature hydrogen soaking may be determined for a specific composition and particle size and nature. Soaking times of about one to three hours have been used in activating Laves phase metal alloys.

The low temperature hydrogen soaking step is followed by quickly releasing the hydrogen pressure (without introducing oxygen) and applying a vacuum to remove all absorbed hydrogen while rapidly heating the material to a temperature from about 100° C. to 200° C., or to about 350° C. Again the specific temperature may be determined by testing of a specific composition and particle size and nature. Where practical, the amount of hydrogen absorbed and released during a process cycle may be measured to determine improvement in storage capacity. Otherwise, a sample of the cycled material may be tested for hydrogen storage, such as by determining a pressure-composition isotherm at a hydrogen storage operating temperature of interest.

The low temperature soaking step and high temperature hydrogen removal step prepares the crystalline hydrogen storage material for fuller and more rapid hydrogen adsorption and release. The steps are repeated as desired until the measured hydrogen absorption and release reaches a value known (or found) to be characteristic of the crystalline composition.

### EXAMPLE 1

An example is given using relatively small particles of arc melted Ti_{1.1}CrMn composition. The arc melted Ti_{1.1}CrMn material was ball milled to yield multifaceted shaped particles of about 20-35 microns in largest dimension.

Initially the particles were placed in a sample holder for excluding oxygen and evacuated for one hour at room temperature (about 25° C.). The material was then cooled to about −190° C. by dipping the sample holder in a temperature to about minus 190° C. within about 5 minutes. Simultaneously, hydrogen pressure was applied and increased to 175 bars. The Ti1.1CrMn alloy was soaked at this cold temperature and hydrogen pressure for 3 hours. After soaking, the sample holder was evacuated of hydrogen and the holder and alloy heated to 100° C. within about 10 minutes using a preheated furnace. Hydrogen was first vented from the sample holder into a receiving vessel in which the recovered hydrogen could be measured. After non-absorbed hydrogen was vented, a vacuum was applied to remove residual hydrogen from the Ti_{1.1}CrMn material. The evacuation of hydrogen at this temperature continued for one hour.

In this example, the sample was processed in a commercial volumetric PCI apparatus to measure hydrogen sorption and hydrogen release during the sorption process. The PCI apparatus provides volumetric measurement using a set of calibrated cylindrical reservoirs with known volume and a set of pressure sensors. Hydrogen gas at known pressures is applied to the samples (or released from the samples) in incremental pressure steps and resulting pressure changes due to absorption or release are measured. Knowing the mass and density of the alloy sample and the pressure changes over the alloy as various applied pressures, the amount of hydrogen absorbed or released by a sample is calculated.

The heated, evacuated sample in its sample holder was then cooled again in liquid nitrogen and soaked with hydrogen gas at a pressure increased to 175 bars. After thus soaking in hydrogen for three hours, the sample was again heated to 100° C. and evacuated of hydrogen as described above. This cooling-soaking and heating-evacuation cycle was repeated a third time during which more than 2 bars hydrogen pressure release from the thus-activated Ti_{1.1}CrMn sample was obtained during heating. The Ti_{1.1}CrMn material after three such activation cycles was accepted as activated for use as a hydrogen storage material.

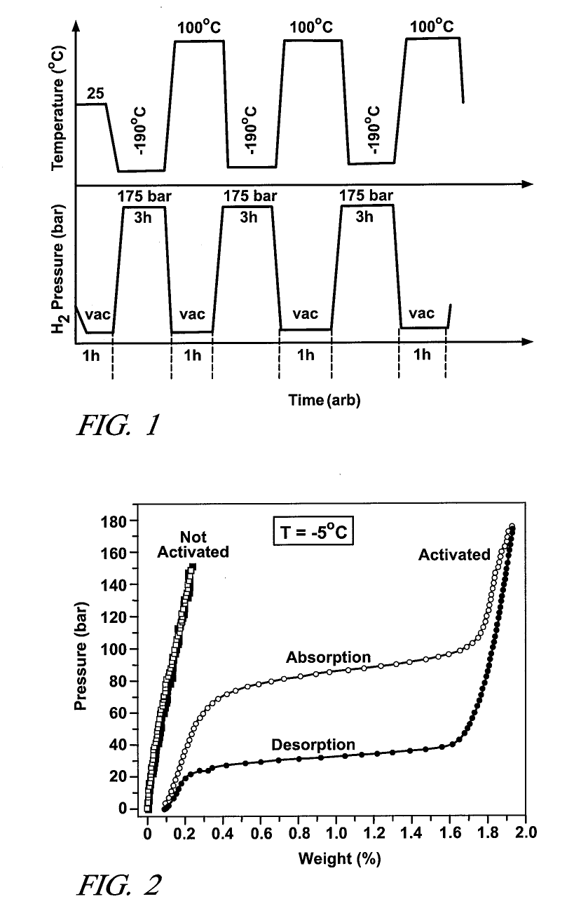

FIG. 1 graphically illustrates the variation of temperature with time (upper curve) and hydrogen pressure with time (lower curve) for this example. The graph illustrates the replication of three activation cycles to activate the hydrogen storage material of this example. In this example, the three activation cycles were each conducted at the same low and high temperatures and hydrogen pressures. This practice of using the same process parameters is convenient and sometimes preferred. But, where desirable, the pressure and temperature conditions may be varied. It is generally preferred to use at least the same purity of hydrogen as may be used in the storage material as a fuel.

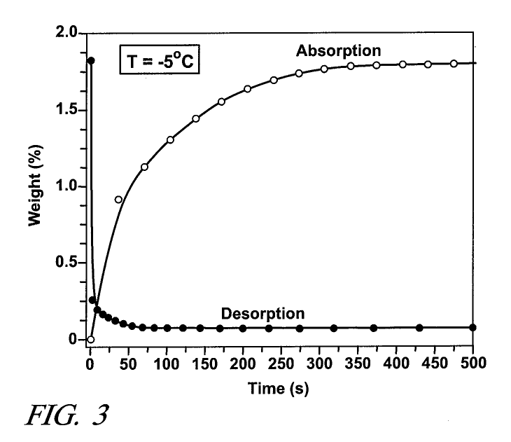

The activated Ti_{1.1}CrMn material was subjected to hydrogen absorption and desorption at −5° C. to determine a pressure-composition isotherm (PCI) at that temperature. A like PCI was prepared using a sample of the same Ti_{1.1}CrMn material that had not been activated. The PCI data for the two samples is seen in FIG. 2 and sorption kinetics of the activated and non-activated samples at −5° C. are presented in FIG. 3.

At −5° C., the sorption capacity of the activated Ti_{1.1}CrMn alloy is ˜1.9 wt % compared to a near zero value for the non-activated Ti_{1.1}CrMn material (FIG. 3). As illustrated in FIG. 2, the sorption pressures, 90 bars for absorption and 30 bars for desorption, matches optimal data reported for Ti_{1.1}CrMn alloys. The sorption kinetics of the activated Ti_{1.1}CrMn exhibits fast kinetics with full absorption and desorption within 300 seconds and 100 seconds, respectively, exceeding the United States Department of Energy promulgated minimum requirements for vehicle refueling times. After activation by the subject method, the hydrogen sorption kinetics of this type of hydrogen storage alloy appears to be fast enough for usage in hydrogen storage tanks for vehicle applications and other applications.

### EXAMPLE 2

In another test, generally spherically shaped particles of ingot Ti_{1.1}CrMn material, about 3-4 millimeters in diameter, were used as starting material for the subject activation method. In the first low temperature/high temperature hydrogen absorption/desorption processing cycle it was found that larger ingot material absorbed a significant amount of hydrogen (close to 2.2 weight percent). The same processing conditions were followed as used in Example 1. It was then found that the Ti_{1.1}CrMn ingot pieces were fully activated for hydrogen absorption/desorption in the second cycle.

Activation of hydrogen storage alloy ingot pieces, or smaller pieces, by the low temperature process indicates that the large volume change during cooling cycles forms cracks and generates the needed fresh surfaces to permit additional and more rapid hydrogen absorption. The fresh and oxide free surface is required for absorption of hydrogen in the alloy. The crystal size of the alloy also increases (about 20-25%) by pressurized hydrogen sorption, and this hydrogen take-up also creates further cracks in the solid material. These complimentary effects of volume change by low temperature cycling and hydrogen absorption process accelerate the grain coarsening and kinetics of the hydrogen sorption.

This activation method is shown to be effective for different alloys than Ti_{1.1}CrMn. The subject low temperature activation process has demonstrated on various substituted alloy ingots such as (Ti₁₋ₓZrₓ)CrMn (x=0.1, 0.15, 0.20, 0.3, and 0.4) and fast activation was observed when only a few (1-3) low temperature hydrogen sorption cycles were applied.

Hydrogen storage alloys often tend to form oxide coatings and may even rapidly oxidize. Accordingly, it may be desired to protect such alloys from oxidation.

In activation, cracking the outermost oxide layer and fracturing the particle to produce voids and additional oxide-free surface area are believed to be necessary and effective steps. The increase in hydrogen receiving surfaces is believed to arise from the initial thermal shock due to cooling and also from a mismatch in the expansion coefficients of alloy and oxide skin. For example, any cracks formed in an oxide layer may provide openings for hydrogen absorption. Once this barrier-oxide layer fractures, the hydrogen may diffuse into the alloy and occupy interstitial sites in the crystal structure. As the alloy absorbs hydrogen, the lattice volume increases and yields more pressure on the surface. This leads to cracking and breaking of the particle and exposing more and fresher surfaces. These effects have been observed by comparing SEM images and XRD data of non-activated and activated TiCrMn containing materials.

Large ingots have lower surface to bulk ratio than powders. In addition, the thermal shock effects on large particles are larger than in smaller ones. Consequently, the large particles (as from broken up ingots) fracture easier, and require fewer low temperature short cycles for activation. In fact, the ingots do not carry as many surface defects as are found in, for example, ball milled powders.

Thus, the temperature cycling method of this invention provides an industrially viable and scalable, activation process to activate transition metal based hydrogen storage alloys. This process eliminates the difficulties and cost of high pressure and high temperature steps by using relatively low hydrogen pressure (compared to compressed hydrogen storage at 350 bars) and low temperature cycles. Further the use of alloy ingots, instead of ball milled alloy powders, may likely eliminate time and energy required for forming small micron sized particles for hydrogen storage. As demonstrated above, chunks of ingot material have been activated by the subject process and found to have PCI properties and hydrogenation kinetics as specified for automotive vehicle applications.

1. A method of preparing a hydrogen storage metal alloy composition for repeated absorption and desorption of hydrogen in a hydrogen storage application, the method comprising:
determining that a solid metal alloy composition material fails to absorb an amount of hydrogen expected to be absorbed by such metal alloy composition;
cooling a quantity of the solid metal alloy composition to a first predetermined temperature below about 0° C. while soaking the solid composition for a predetermined time period under an atmosphere consisting essentially of hydrogen at a predetermined pressure for hydrogen absorption into the solid composition; then
heating the solid metal alloy composition from the first temperature to a second predetermined temperature at or above about 100° C. while removing the hydrogen atmosphere and reducing the pressure on the solid metal alloy composition to promote desorption of absorbed hydrogen from the solid metal alloy composition; the first predetermined temperature, the predetermined hydrogen soaking time, the predetermined pressure for hydrogen absorption, and second predetermined temperature each being selected for increasing the capacity of the metal alloy composition material to subsequently absorb and desorb hydrogen;
determining the amount of hydrogen desorbed from the solid metal alloy composition; and, as necessary,
subjecting the solid metal alloy composition to repeated cooling, hydrogen soaking, and hydrogen absorption, followed by heating, and hydrogen desorption until the determined amount of hydrogen desorbed from the solid metal alloy composition reaches a predetermined amount.

2. A method of preparing a hydrogen storage metal alloy composition for absorption of hydrogen as recited in claim 1 in which the solid metal alloy composition comprises a Laves phase material.

3. A method of preparing a hydrogen storage metal alloy composition for absorption of hydrogen as recited in claim 1 in which the solid metal alloy composition comprises a Laves phase material containing titanium and chromium, or titanium, chromium. and manganese.

4. A method of preparing a hydrogen storage metal alloy composition for absorption of hydrogen as recited in claim 1 in which the first temperature and any repeated cooling temperatures are in the range from about 0° C. to about −190° C.

5. A method of preparing a hydrogen storage metal alloy composition for absorption of hydrogen as recited in claim 1 in which the pressure of the hydrogen atmosphere during the first cooling step or any repeated cooling step is in the range of from about 50 bars to 200 bars.

6. A method of preparing a hydrogen storage metal alloy composition for absorption of hydrogen as recited in claim 1 in which the duration of the first cooling step or any repeated cooling step is in the range of about one to three hours.

7. A method of preparing a hydrogen storage metal alloy composition for absorption of hydrogen as recited in claim 1 in which the second temperature and any repeated heating temperature is in the range from about 100° C. to about 350° C.

8. A method of preparing a hydrogen storage metal alloy composition for absorption of hydrogen as recited in claim 1 in which the hydrogen storage metal alloy composition is newly prepared by fusion of the elemental constituents of the composition and the material to be prepared comprises pieces of solidified ingots of the prepared composition.

9. A method of preparing a hydrogen storage metal alloy composition for absorption of hydrogen as recited in claim 1 in which the first temperature and any repeated cooling temperatures are in the range from about −300° C. to about −190° C.

10. A method of preparing a hydrogen storage metal alloy composition for absorption of hydrogen as recited in claim 1 in which the second temperature and any repeated heating temperature is in the range from about 100° C. to about 200° C.

11. A method of preparing a hydrogen storage metal alloy composition for absorption of hydrogen as recited in claim 1 in which a quantity of the solid metal alloy composition is cooled to a first predetermined temperature using liquid nitrogen.

12. A method of preparing a hydrogen storage metal alloy composition for absorption of hydrogen as recited in claim 1 in which a quantity of the solid metal alloy composition is cooled to a first predetermined temperature using a dry ice-alcohol bath.
